(19) United States
(12) Patent Application Publication
(10) Pub. No.: US 2005/0280704 A1
(43) Pub. Date: Dec. 22, 2005

(54) Method of video monitoring, corresponding device, system and computer programs

(75) Inventors: Maryline Clare, Rennes (FR); Xavier Henoco, Acigne (FR)

Correspondence Address: FITZPATRICK CELLA HARPER & SCINTO, 30 ROCKEFELLER PLAZA, NEW YORK, NY, 10112, US

(73) Assignee: CANON EUROPA NV, Amstelveen (NL)

(21) Appl. No.: 10/964,675

(22) Filed: Oct. 15, 2004

(30) Foreign Application Priority Data
Oct. 16, 2003 (FR) 03 12123

(51) Int. Cl. H04N 7/18

(52) U.S. Cl. 348/143; 348/155

(57) ABSTRACT

A video monitoring device, comprising: receiving means for receiving a video stream from a video source; manually operable means for setting a detection mode among at least two modes, the detection mode being solely set for the video source; motion detection means for detecting motion in the video stream in accordance with the detection mode set by said manually operable means, said motion detection means obtaining and computing a set of images from the video stream according to the detection mode; and output means for outputting the result regarding to the motion detected by said detection means.

This application claims the right of priority under 35 USC § 119 based on French Patent Application number 03 12123 filed 16 Oct. 2003.

### 1. FIELD OF THE INVENTION

The present invention relates to the field of digital video encoding and transmission. More specifically, the invention proposes a novel technique for the detection of motion, adapted to the monitoring services to be provided.

### 2. DESCRIPTION OF THE PRIOR ART

Video monitoring or surveillance applications are very well known and widely used. Providers of home local area network solutions propose integrated video monitoring systems, but with functions limited to permanent viewing or anti-intruder alarms (for example).

Many classic video monitoring systems rely on the detection of motion or presence through sensors: thus the U.S. Pat. No. 6,525,659, “Automatic sliding doors for refrigerator unit” by Jaffe et al. describes sensors detecting human presence before a door, capable of opening this door automatically. These techniques have the drawback of offering limited functions.

Some commercially available systems propose techniques providing for detection of motion through an analysis of video streams.

Thus, the U.S. Pat. No. 6,081,606 by Hansen et al “Apparatus and a method for detecting motion within an image sequence” describes a system of video monitoring that is particularly well-suited to airport security, but its ultimate purpose is to know the direction of a suspicious movement when it is detected. It differentiates between several types of motion: slow, medium and fast. When no slow motion is detected, then it is the search for medium motion or fast motion which may be implemented by an automatic adaptation of a motion activity threshold. According to this technique, only one type of service is proposed. The detection of motion based on a comparison of frames two by two indeed entails limitations. This technique also has the drawback of not been suited to home networks and, especially, of not being capable of redirecting an alarm towards a person who is normally present in the monitoring premises or close to them.

The technique illustrated in the U.S. Pat. No. 5,959,681 by Yong-Hun Cho, “Motion picture detecting method” distinguishes fast motion blocks and slow motion blocks between two successive frames. Its aim is to convert an interlaced video (where two successive frames are in fact half-frames, the first containing even-parity lines and the second containing odd-parity lines, and are acquired within intervals of a few milliseconds) into progressive video (where two successive frames are combined into a single frame, which therefore has all the vertical resolution, but could have small shifts if a motion occurs during the acquisition time). Knowledge of the speed of motion makes it possible to achieve a more precise recomposition of the frames locally on the different blocks thus identified.

The U.S. Pat. No. 6,418,168 by Narité and al entitled “Motion vector detection apparatus, method of the same, and image processing apparatus” describes a motion detection technique optimizing the motion analysis search space in the event of fast motion. This search space is actually a set of blocks of an image preceding the image for which the motion encoding is in progress.

The technique covered by the U.S. Pat. No. 5,351,083 by Tsukagoshi and al. entitled “Picture encoding and/or decoding system” aims at encoding motion in a video differently when the motion is fast or when it is slow. The motion vectors are analyzed to find out if the system is in the presence of fast motion or slow motion and, depending on the case, a different quantification is applied to the encoding of these blocks.

The different techniques have the drawback of being limited to motion detection between two frames. Furthermore, they are relatively complex to implement and their cost is often prohibitive. They are therefore not suited to a home network.

### 3. SUMMARY OF THE INVENTION

The invention according to its different aspects has the goal especially of overcoming these drawbacks of the prior art.

More specifically, it is a goal of the invention to provide a motion detection system and a method that are particularly well suited to different video monitoring services cohabiting in a same system.

It is another goal of the invention to implement motion detection well suited to home monitoring. In particular, it is aimed at enabling several types of monitoring, especially the detection of intruders and the monitoring of infants, in a manner that is simple to implement and economical.

The present invention is also aimed at facilitating the use of a home video device in order to add a video monitoring function to it.

To this end, the invention proposes a video monitoring device, comprising
receiving means for receiving a video stream from a video source,
manually operable means for setting a detection mode among at least two modes, the detection mode being solely set for the video source;
motion detection means for detecting motion in the video stream in accordance with the detection mode set by said manually operable means, said motion detection means obtaining and computing a set of images from the video stream according to the detection mode; and
output means for outputting the result regarding to the motion detected by said detection means.

According to one particular characteristic of the invention, at least a number of images within the set of images obtained by said motion detection means and duration of the video stream during which the set of images are obtained by said motion detection means are determined according to the detection mode.

According to one particular characteristic of the invention, said output means includes alarm means for generating an alarm signal based on the motion detected by said motion detection means.

According to one particular characteristic of the invention, the video monitoring device further comprises means for detecting sound level in an audio stream associated with the video stream, and wherein said alarm means generates the alarm signal if the weighted sum of the detected sound level and level of the motion detected by said motion detection means is above a threshold that is dependent on the detection mode set for the video source.

According to one particular characteristic of the invention, said alarm means includes selecting means for selecting a video display among a plurality of displays and supply means for supplying the video stream to the selected video display.

According to one particular characteristic of the invention, said receiving means is capable of receiving a plurality of video streams from a plurality of video sources, said selecting means selects the display closer to a video source belonging to a predetermined set of video sources.

According to one particular characteristic of the invention, said predetermined set of video sources includes all the video sources among the plurality of video sources but the one from which the video stream causing the alarm signal is received.

According to one particular characteristic of the invention, the video stream is intra-frame encoded and said motion detection means includes means of computing difference between images within the obtained set of images.

According to one alternative embodiment of the invention, the video stream is inter-frame encoded and said motion detection means uses motion vectors associated with an image within the obtained set of images.

The invention also relates to a video monitoring device, comprising
an input receiving a video stream from a video source,
a manual operable member setting a detection mode among at least two modes, the detection mode being solely set for the video source;
a motion detector detecting motion in the video stream in accordance with the detection mode set by the manual operable member, the motion detector obtaining and computing a set of images from the video stream according to the detection mode; and
an output outputting the result regarding to the motion detected by the motion detector.

According to one particular characteristic of the invention, at least a number of images within the set of images obtained by the motion detector and duration of the video stream during which the set of images are obtained by the motion detector are determined according to the detection mode.

The invention also relates to a method of video monitoring, comprising
a step for receiving a video stream from a video source,
a step for manually setting a detection mode among at least two modes, the detection mode being solely set for the video source;
a step for detecting motion in the video stream in accordance with the detection mode set, in order to obtain and compute a set of images from the video stream according to the detection mode; and
a step for outputting the result regarding to the motion detected.

According to one particular characteristic of the invention, at least a number of images within the set of images obtained by said step for detecting motion and duration of the video stream during which the set of images are obtained by said step for detecting motion are determined according to the detection mode.

According to one particular characteristic of the invention, said step for outputting includes a step for generating an alarm signal based on the motion detected by said step for detecting motion.

According to one particular characteristic of the invention, the method further comprises a step for detecting sound level in an audio stream associated with the video stream, and said step for generating an alarm signal allows to generate the alarm signal if the weighted sum of the detected sound level and level of the motion detected by said motion detection means is above a threshold that is dependent on the detection mode set for the video source.

According to one particular characteristic of the invention, said step for generating an alarm signal includes a step for selecting a video display among a plurality of displays and a step for supplying the video stream to the selected video display.

According to one particular characteristic of the invention, said step for receiving allows to receive a plurality of video streams from a plurality of video sources, said step for selecting allowing to select the display closer to a video source belonging to a predetermined set of video sources.

According to one particular characteristic of the invention, said predetermined set of video sources includes all the video sources among the plurality of video sources but the one from which the video stream causing the alarm signal is received.

According to one particular characteristic of the invention, the video stream is intra-frame encoded and said step for detecting motion includes a step for computing difference between images within the obtained set of images.

According to one alternative embodiment of the invention, the video stream is inter-frame encoded and said step for detecting motion uses motion vectors associated with an image within the obtained set of images.

The invention also relates to a computer program product comprising computer program code means for performing the steps of aforesaid method according to the invention when said computer product is run on a computer.

The invention also relates to a computer readable storage medium, possibly partially or totally removable, storing a set of machine executable instructions, said set of machine executable instructions being executable by a computer to perform the steps of aforesaid method according to the invention.

The invention also relates to a method of video monitoring in a communications network comprising at least one video camera, the method including a reception of at least one data stream sent out by at least one of the video cameras, each of the data streams comprising several images, the method furthermore comprising:
a configuring of the video camera or cameras in a mode of detection determined from among at least two distinct modes;
a detection of motion in the data stream or data streams according to the detection mode; and
a generation of at least one alarm signal in the network if at least one motion has been detected according to the mode of detection.

Thus, the configuring step is facilitated: the detection modes are, indeed, preferably predetermined as a function of the different possible applications, for example intruder detection or child monitoring functions. Thus, the detection mode is particularly well suited to the application and is therefore more efficient.

According to a particular characteristic of the method, the detection mode is associated with a type of application implemented by at least one of the video cameras.

Thus, one or more cameras implement a particular application and the detection mode can be modified as a function of the associated application. In this way, a more reliable detection is obtained and there is a reduction in the risk of having alarms unnecessarily triggered or, on the contrary, the risk that motion being looked for will not be detected.

According to different embodiments of the invention, the detection mode is updated in configuration tables proper to the applications and/or to the associated cameras implicitly or explicitly with respect to particular applications.

According to a particular characteristic of the method, the detection mode belongs to a set comprising:
the detection of slow motions; and
the detection of fast motions.

Thus, the detection mode associated with a slow or fast motion is made reliable and the resources (bandwidth on communications links, memory and computation resources in particular) used are economized: for a detection of slow motion, the method preferably analyses several images over a long duration (preferably greater than 20 seconds) whereas for a detection of fast motion, the duration of analysis will be far shorter (preferably about 5 seconds).

Furthermore, the method is well suited to the usual applications in a house, especially the monitoring of children (preferably associated with a detection of slow motion) and the identification of undesired intrusion (preferably associated with the detection of fast motion).

According to particular characteristic of the method, the motion detection is done in taking account of at least three images in a data stream.

Thus, the motion detection is made reliable.

According to a particular characteristic of the method, the motion detection is performed in taking account of all the images in one of the data streams for a predetermined duration.

Thus, the reliability of the motion detection is even further improved.

According to a particular characteristic of the invention, the method includes a step for the configuration of duration.

The invention thus enables adaptation to the user's needs in a way that is flexible and easy to implement.

According to a particular characteristic of the invention, the method comprises a step for the identification of the type of data stream received and for the performance of a corresponding processing operation.

Thus, the detection of motion and therefore the corresponding processing operation are optimized as a function of the type of data stream, for example, compatible with the formats defined according to the mini-DV, motion-JPEG, MPEG-2 or MPEG 4 formats. The method is suited to the processing of data that can be especially encoded according to motion-based encoding or frame-based encoding. The method is also suited to processing images coming from cameras of different types. Thus, the method can be advantageously implemented in an environment that could include cameras of different types and models (for example, camescopes, webcams etc).

According to a particular characteristic of the invention, the method includes a transmission of a piece of information representing a generated alarm signal to a set comprising at least one display terminal.

Thus, the invention enables a direct communication of a piece of monitoring information to a user without his or her necessarily being before a dedicated screen.

According to particular characteristic of the invention, the method comprises a step for the dynamic determining of the set comprising at least one display terminal.

Thus, the method is particularly well suited to implementation in a home environment or an environment of small offices having one or more display terminals (for example television sets or computer screens).

According to a particular characteristic of the method, the dynamic determining step comprises an operation of motion detection so as to determine the presence of a person close to a terminal belonging to the network and insert the corresponding terminal into the set comprising at least one display terminal.

Thus, the method enables the accurate targeting of a person capable of verifying if everything is all right as a function of the application without unnecessarily using resources and/or equipment additional to the network.

According to a particular characteristic of the method, the dynamic determining comprises:
a step for memorizing the detection mode known as the original detection mode;
a step for the configuring of a detection mode, known as a mode with dynamic determining of persons, making it possible to determine the presence of a person; and
a step of switching from the detection mode with dynamic determining of persons to the original detection mode, according to a predetermined rule.

Thus, the method makes it possible to identify a person to be alerted by using the same basic elements (especially cameras) and infrastructure (network in particular) as the means proper to video monitoring.

According to one alternative embodiment, the method switches into a mode of identification by which it can identify a person to be alerted and returns to the origin identification mode according to a predetermined rule, for example at the expiry of a time lag or again after reception of a piece of validation information by a local user (for example, the person identified) or distant user (if, for example, no person has been identified locally).

According to a particular characteristic of the method, the data stream furthermore comprises sound data and the method comprises:
a detection of noise in the data stream or data streams having an intensity greater than a predetermined threshold according to the configurable detection mode; and
a generation of at least one alarm signal on the network if at least one noise having a level above the predetermined threshold is detected according to the configurable detection mode.

Thus, the detection, which is carried as a function of a detection of both noise and motion in a stream of several corresponding images, is made reliable.

The sound detection can be implemented especially during, before or after a detection of motion in a particular data stream:
a sound detection implemented before a motion detection simplifies the implementation, a sound detection being generally simpler to carry out than a detection of motion;
a sound detection implemented after a motion detection enables the motion detection to be confirmed or not confirmed; and
a joint detection of sound and of motion enables a finer analysis.

In any case, the results of the sound detection and of a motion detection can be weighted as a function of the application, to activate or not activate an alarm.

The invention also relates to a video monitoring device designed to be implemented in a communications network comprising at least one video camera, the device comprising means for the reception of at least one data stream sent by at least one of the video cameras, each of the data streams comprising several images, the device further comprising:
means for the configuring of the video camera or cameras in a mode of detection determined from among at least two distinct modes;
means for the detection of motion in the data stream or data streams according to the detection mode; and
means for the generation of at least one alarm signal on the network if at least one motion has been detected according to the detection mode.

According to one particular characteristic of the device, the detection mode is associated with a type of application implemented by at least one of the video cameras.

According to particular characteristic of the device, the detection mode belongs to a set comprising;
the detection of slow motions; and
the detection of fast motions.

According to one particular characteristic of the device, the detection of motion is done in taking account of at least three images in a data stream.

According to one particular characteristic of the device, the detection of motion is done in taking account of all the images in a data stream for a predetermined duration.

According to one particular characteristic of the invention, the device comprises means for the configuring of the duration.

According to one particular characteristic of the invention, the device comprises means to identify the type of data stream received and the corresponding processing operation.

According to one particular characteristic of the invention, the device comprises means for the transmission of a piece of information, representing a generated alarm signal, to a set comprising at least one display terminal.

According to one particular characteristic of the invention, the device comprises means for the dynamic determining of the set comprising at least one display terminal.

According to one particular characteristic of the device, the dynamic determining means comprise motion detection means so as to determine the presence of a person close to a terminal belonging to the network and to insert the corresponding terminal in the set comprising at least one display terminal.

According to one particular characteristic of the device, the dynamic determining means comprise:
means for memorizing the detection mode, called the original detection mode;
means of configuring in a detection mode, called the mode for the dynamic determining of persons, making it possible to determine the presence of a person; and
means for switching from the detection mode with dynamic determining of persons to the original detection mode, according to a predetermined rule.

According to a particular characteristic of the device, the data stream furthermore comprises sound data and the device comprises:
means for the detection of noise in the data stream or streams having an intensity higher than a predetermined threshold according to the configurable detection mode; and
means for the generation of at least one alarm signal on the network if at least one noise at a level higher than the predetermined threshold is detected according to the configurable detection mode.

The invention furthermore relates to a system of video monitoring designed to be implemented in a communications network comprising at least one video camera, the system comprising means for the reception of at least one data stream sent out by at least one of said video cameras, each of the data streams comprising several images, the system furthermore comprising:
means for the configuring of the video camera or of video cameras in a mode of detection determined from among at least two distinct modes;
means for the detection of motion in the data stream or data streams according to the detection mode; and
means for the generation of at least one alarm signal on the network if at least one motion has been detected according to the detection mode.

The invention also relates to a computer program product comprising program elements, recorded on a support readable by at least one microprocessor, wherein the program elements control the microprocessor or microprocessors so that they carry out video monitoring in a communications network comprising at least one video camera, the program elements carrying out:
a reception of at least one data stream sent out by at least one of the video cameras, each of the data streams comprising several images,
a configuring of at least the video camera or of video cameras in a mode of detection determined from among at least two distinct modes;
a detection of motion in the data stream or data streams according to the detection mode; and
a generation of at least one alarm signal in the network if at least one motion has been detected according to the mode of detection.

The invention also relates to a computer program product comprising instruction sequences adapted to the implementation of a method of video monitoring described here above according to the invention when the program is executed on a computer.

The advantages of the device, the system and the computer program products are the same as those of the method of video monitoring and shall not be described in fuller detail.

### 4. BRIEF DESCRIPTION OF THE FIGURES.

Other features and advantages of the invention shall appear more clearly from the following description of a preferred embodiment, given by way of a simple, illustrative and non-exhaustive example, and from the appended drawings, of which:

FIG. 1 is a block diagram of a monitoring system according to the invention in a particular embodiment;

FIG. 2 is a schematic illustration of a network associated with the monitoring system of FIG. 1;

FIG. 3 describes a device forming a node of the network of FIG. 2;

FIGS. 4 and 5 present schematic views of a configuration of the system of FIG. 1; and

FIGS. 6a, 6b, 7 and 8 provide a schematic illustration of the monitoring algorithms implemented in the system of FIG. 1.

### 5. DETAILED DESCRIPTION OF THE INVENTION

The general principle of the invention is based on a network comprising one or more cameras that transmit video streams to a node of a network working at high bit rates. This node includes means for detecting motion. This detection is done as a function of a configuration made by a user who associates each camera with a particular type of detection corresponding to a sudden motion or a slow motion with a duration of varying length. Thus, the node implements the detection by integrating the differences between two consecutive images on a detection window whose length depends on the configuration. If the totalized differences exceed an alarm threshold that is configurable, then the node memorizes the analyzed video stream and transmits a piece of visual and/or sound alarm information, and/or the corresponding video stream to a display terminal (a computer or television screen for example) enabling the user to be informed by the overlay of this data on the screen of the terminal.

According to one variant of the invention, the system comprises means to detect the presence of a user in the vicinity of the display terminal. Thus, the detection of the motions of this user according to the configuration associated with a camera, enables a piece of alarm information and/or the video stream to be rerouted to the display terminal closest to the detected user.

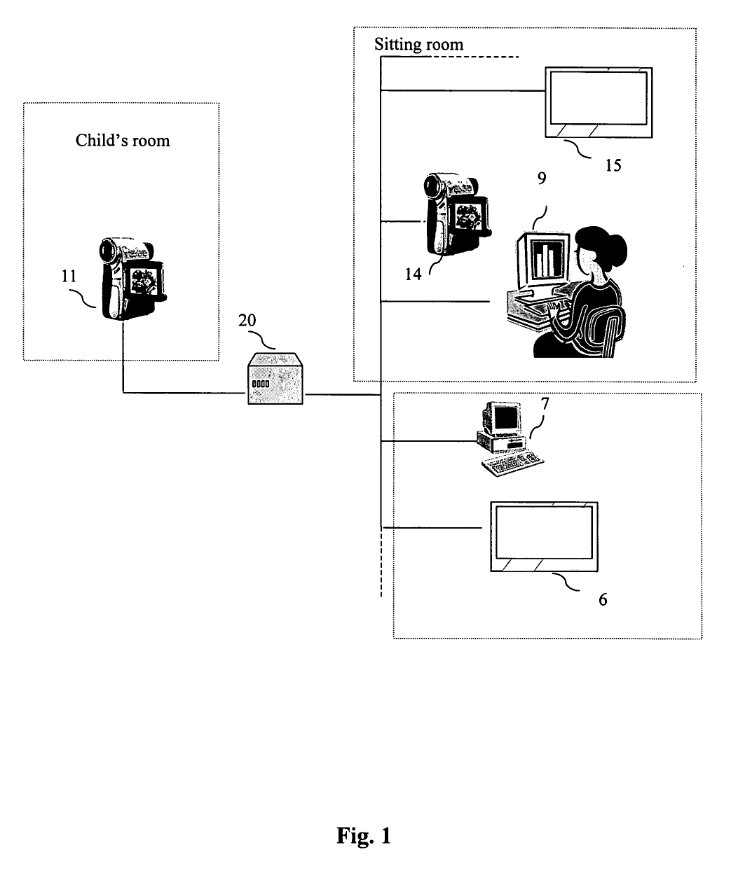

Referring to FIG. 1, a description is given of an embodiment of a monitoring system according to the invention according to a particular embodiment comprising the following connected to each other by a communications network 1 (for example of the home local area network type):
two cameras 11 and 14 of the DV (digital video) type or based on the MPEG2 and MPEG4 standards;
a video monitoring management node 20 called a network terminal;
two computers 7 and 9; and
a television set 6.

The network 1 is for example of the type described in the French patent application by the firm Canon Inc (registered name) published under No. 2 820 921, and entitled “Dispositif et procédé de transmission dans un commutateur” (corresponding to the patent application filed under No. U.S. 2002-012-6657 with the title “Device and method of transmission in a selector switch”). It comprises in particular means of transmission and switching at high bit rates, enabling the transmission of video streams between two nodes of the network. More specifically, the above-mentioned patent illustrates a network implementing:
an exchange protocol; and
an arbitration matrix in a switching module capable of receiving and sending data from several sources, especially through IEEE 1394 and/or IEEE 1355 type interfaces.

After being configured by a user, the node 20 implements a motion detection operation based on different formats, especially the DV, MPEG2 or MPEG4 formats.

The camera 11 permanently films a zone of the room in which it is placed (for example a child's room) and continuously or almost continuously transmits the corresponding video stream to the node 20. The node 20 analyses the video stream that it receives and determines whether or not it should transmit an alarm (or an alarm signal) to a user, depending on the configuration made by the user.

Thus, if the configuration of the camera 11, stored by the node 20, corresponds to intruder detection, then the node 20 analyses the stream received during a period of some seconds, determining the differences between all the consecutive images belonging to a window with a duration of some seconds. If the sum of the differences (or totalized difference) is above a certain threshold, then an abrupt motion, which may correspond to an intrusion, is detected.

Thus, if the configuration of the camera 11, stored by the node 20, corresponds to the monitoring of an infant, the node 20 analyses the stream received over a longer period. If the totalized difference over this period is above a certain threshold, then a slow motion, likely to correspond to an infant's awakening, is detected.

After the crossing of the threshold for detection of fast or slow motion depending on the configuration, the node 20 transmits an alarm signal to the computer 9 or to the television set 6 which displays the place (as it appears in the configuration) corresponding to the camera 11, an alarm identifier and the images filmed by the camera 11. The user can thus verify the nature of the disturbance.

According to one variant of the invention, the camera 14 placed in the room in which the computer 9 is located (for example the sitting room of the house) is activated if the node detects a disturbance associated with a camera 11. If, after analysis of a video stream transmitted by the camera 14, the node 20 detects a slow motion (which could correspond to the presence of a user), it automatically transmits the alarm corresponding to the camera 11 to the control terminal or terminals located in the same room at the camera 14 (in this case the computer 9 and the television set 15).

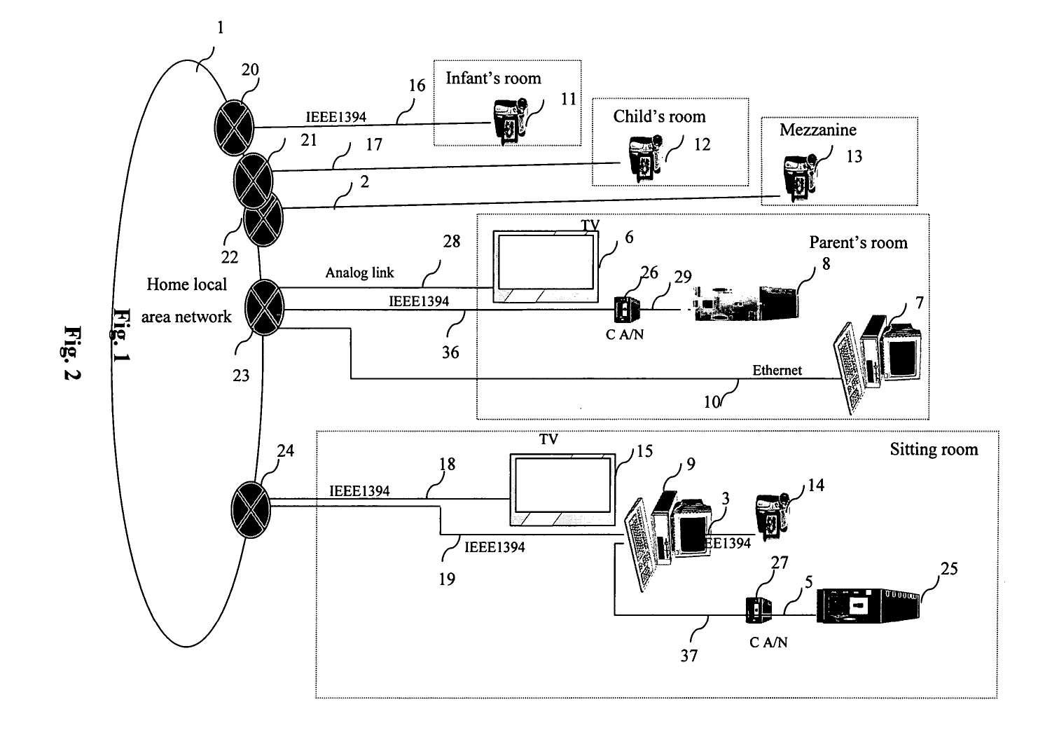

FIG. 2 illustrates the network 1 presented earlier with reference to FIG. 1.

More specifically, in each room of the house, audiovisual devices 11, 12, 13, 6 to 9 and 15 are connected through analog links 5, 28 and 29 or digital links 3, 10, 16 to 19 and 36 (of the Internet or IEEE 1394 type) to “network terminals” 20 to 24 which interface with the rest of the network 1 throughout the house. These audiovisual devices are display peripherals, for example:
display terminal such as 6 and 15 or the computers 7 and 9;
video acquisition peripherals 11, 12, 13 and 14 for example of the camera type (especially camescopes or webcams);
pre-recorded video reading peripherals, especially a digital video disk (DVD) player 8, a video-cassette recorder 25, and the computers 7 and 9.

The network terminal 23 has a digital/analog converter and an analog/digital converter; it can therefore directly accept analog data (for example through the link 28).

An analog link can also be connected to a network terminal through a digital/analog converter or a bridge. Thus, to connect the peripherals 8 and 25 respectively having analog inputs/outputs to the local area network 1, converters 26 and 27 respectively convert the analog input/output signals into digital signals (conveyed on the IEEE 1394 type links 36 and 37) so that the information can be analyzed by the network terminals 20 to 24. The links of the digital peripherals are, for example, of the IEEE 1394 type (for the cameras 11 to 14 and the computer 9) or of the Ethernet type for the computer 7. The television sets 6 and 15 are respectively connected to a node (or network terminal) by a link that is respectively an analog link 28 and a digital link 18 of the IEEE 1394 type.

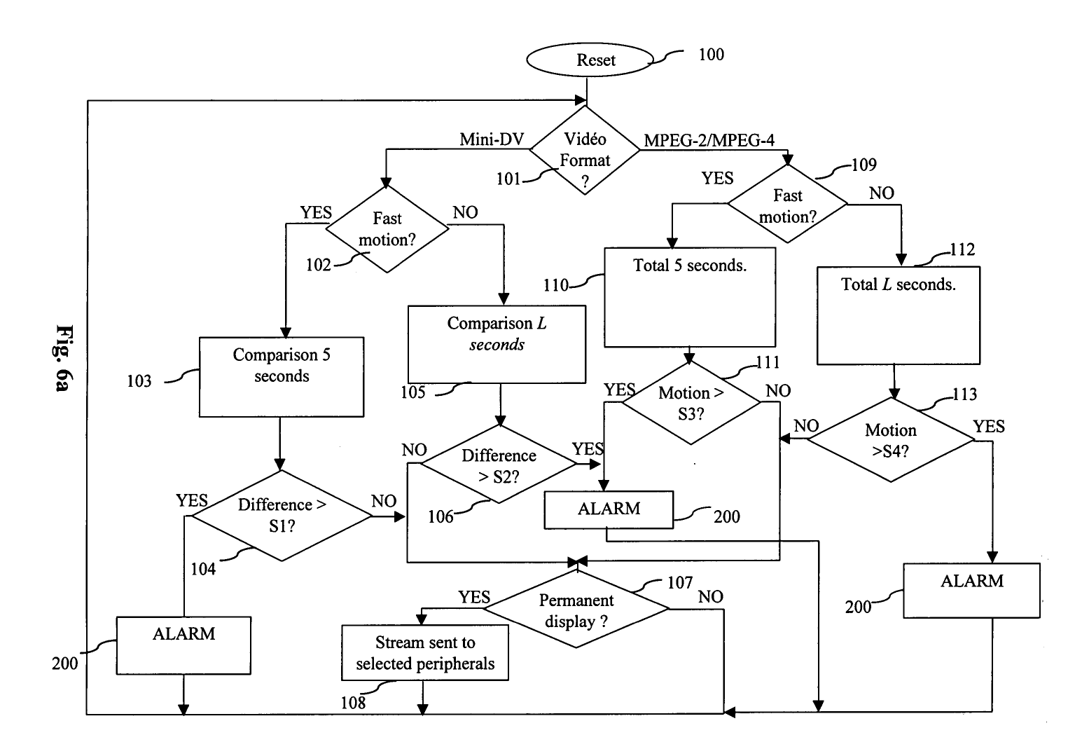

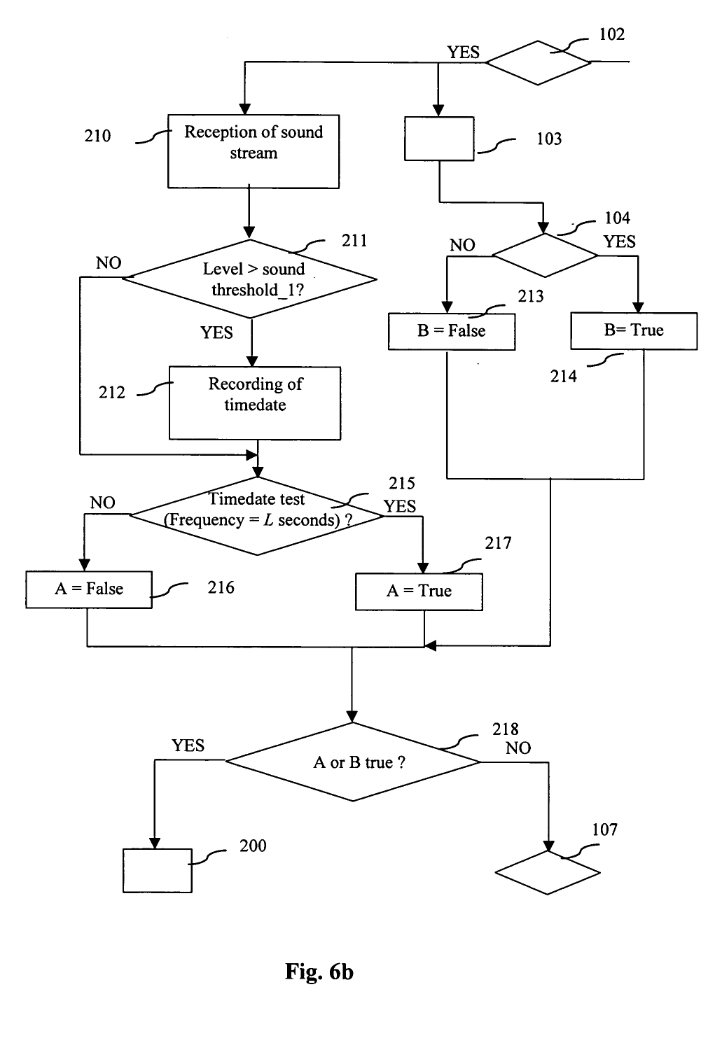

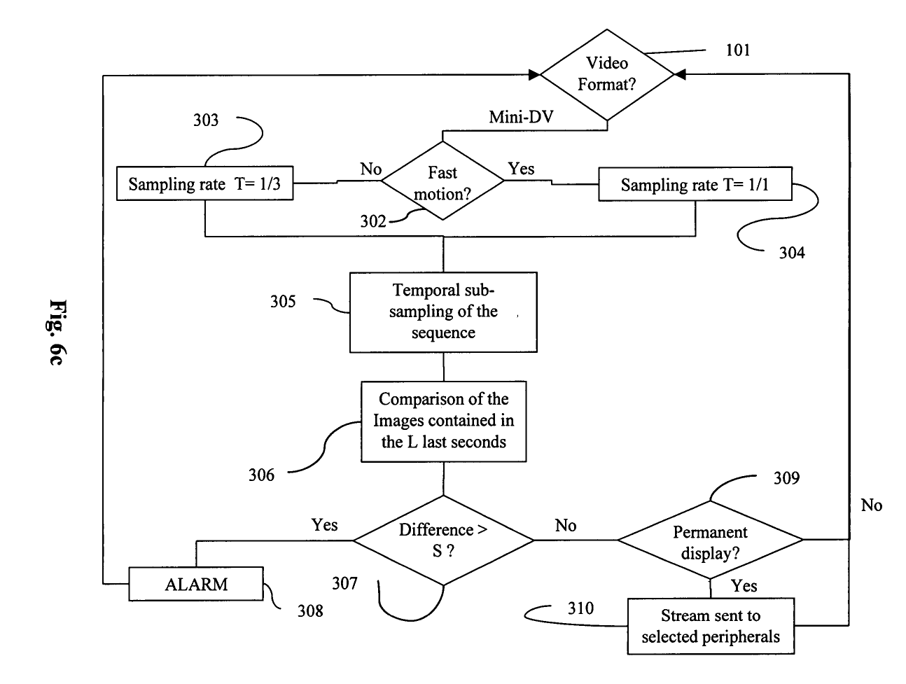

According to a preferred embodiment, the network 1 has several nodes 20 to 24 implementing video monitoring algorithms illustrated with reference to FIGS. 6a, 6b, 7 and 8. In the network, each node 20 to 24 knows the peripherals that are connected to it in this room as well as their state (whether they are active or inactive).

According to one variant of the invention, the network comprises only one central node enabling centralized operation. This node is connected directly or through a network to each of the cameras and to each of the control, video display and/or video stream storage peripherals. It also implements video monitoring algorithms illustrated with reference to FIGS. 6a, 6b, 7 and 8.

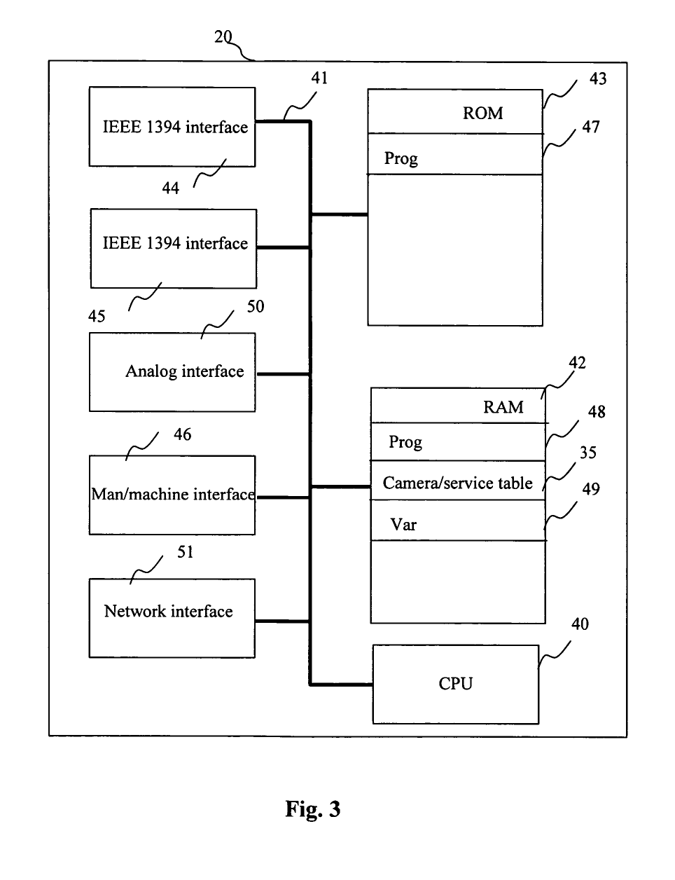

FIG. 3 is a schematic illustration of a device corresponding to a node 20 as illustrated with reference to FIG. 1 (the nodes 21 to 24 have a similar structure).

The node 20 has the following elements connected to each other by an address and data bus 41:
a processor 40;
a random-access memory 42;
a read-only memory 43;
two IEEE 1394 digital interfaces 44 and 45;
an analog interface 50;
an interface 51 with the local network 1; and
a man/machine interface 46.

Each of the elements illustrated in FIG. 3 is well known to those skilled in the art. These common elements are not described here.

It must be noted that, for each of the memories mentioned, the word “register” used throughout the description designates a low-capacity memory zone (corresponding to a few bits) as well as a high-capacity memory zone (enabling the storage of an entire program or an entire sequence of transaction data).

The read-only memory 43 keeps the operating program of the processor 40 in a register “prog” 47. For convenience's sake, these registers have the same names as the data that they store.

The algorithms implementing the steps of the method described here below, especially with reference to FIGS. 6a, 6b, 7 and 8, are stored in the read-only memory 43 associated with the node 20 implementing steps of these algorithms. When the system is powered on, the processor 40 loads and executes the instructions of these algorithms.

The random-access memory 42 keeps data, variables and intermediate processing results and comprises especially:
the operating program <<prog>>48 of the processor 40, loaded when the node 40 is powered on;
a service table 35 associated with each camera connected to the node 20; and
operating variables of the program 48 in a register 49.

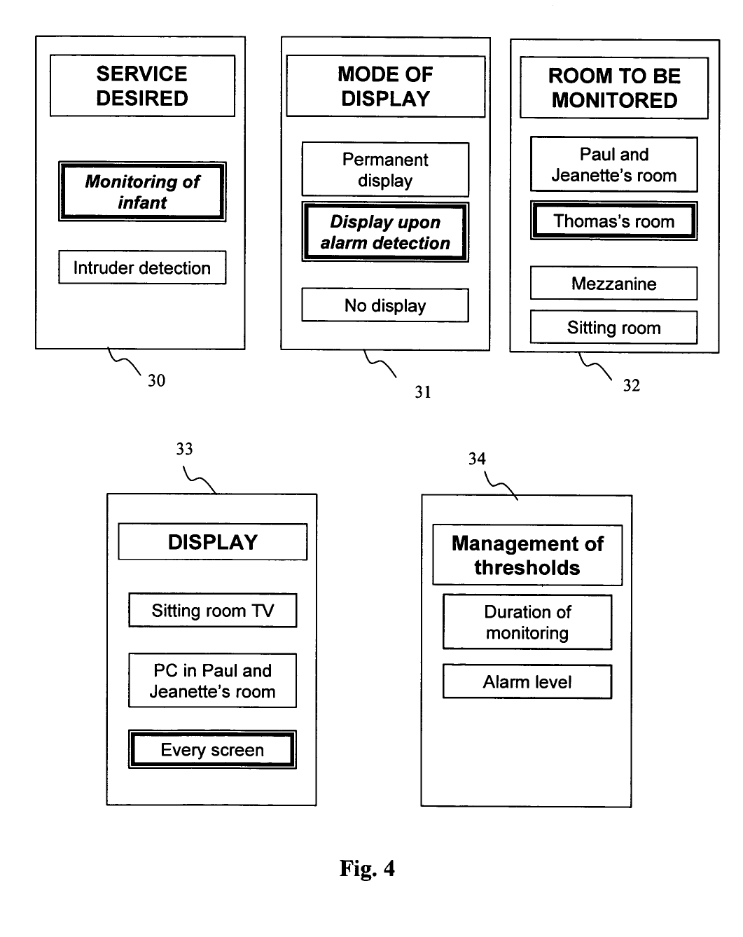

FIG. 4 gives a view, by way of an illustration, of a configuration of a network terminal 20 to 24 carried out through a control terminal (for example the computer 9 or one of the television sets 6 or 15 associated with a remote control). The control terminal has several menus 30 to 34. The menus enable the interactive configuring of the nodes 20 to 24.

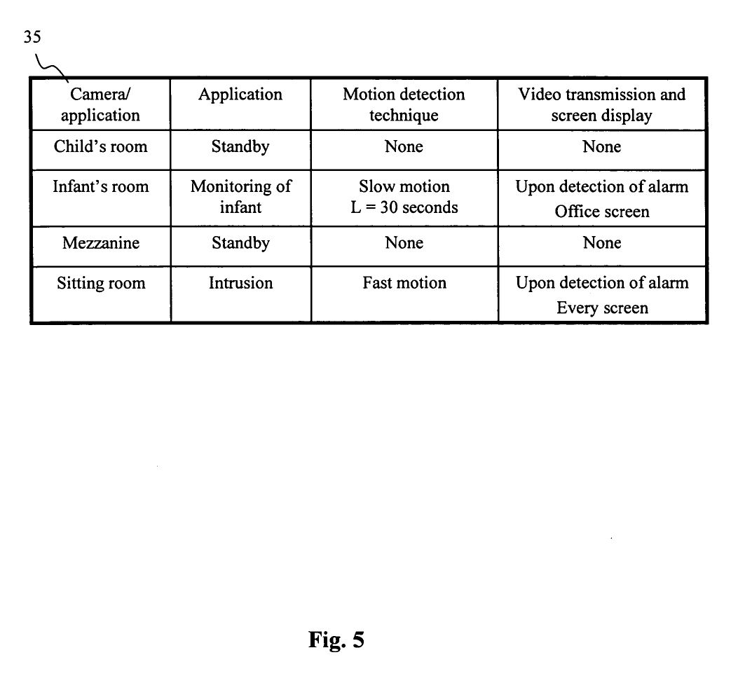

The menu 30 represents the first step of such a configuring operation: the user chooses a type of service desired, for example the monitoring of an infant or the detection of intrusion. The selection of one of these services activates the updating of the table shown in FIG. 5 in taking account of the different technical characteristics of the services proposed. Thus the infant monitoring application, for example, corresponds to the detection of an abnormally lengthy, not necessarily sudden motion, which is herein called a “slow motion over a given time interval”. The detection of intrusion for its part is characterized by the sudden appearance of an individual in a scene, and this sudden appearance is herein called “fast motion”. Naturally, the invention is also compatible with combined video and audio detection which will enable the activation of an alarm also upon the detection of screaming or crying in the case of infant monitoring or upon the detection of abnormal noise in the case of intruder detection.

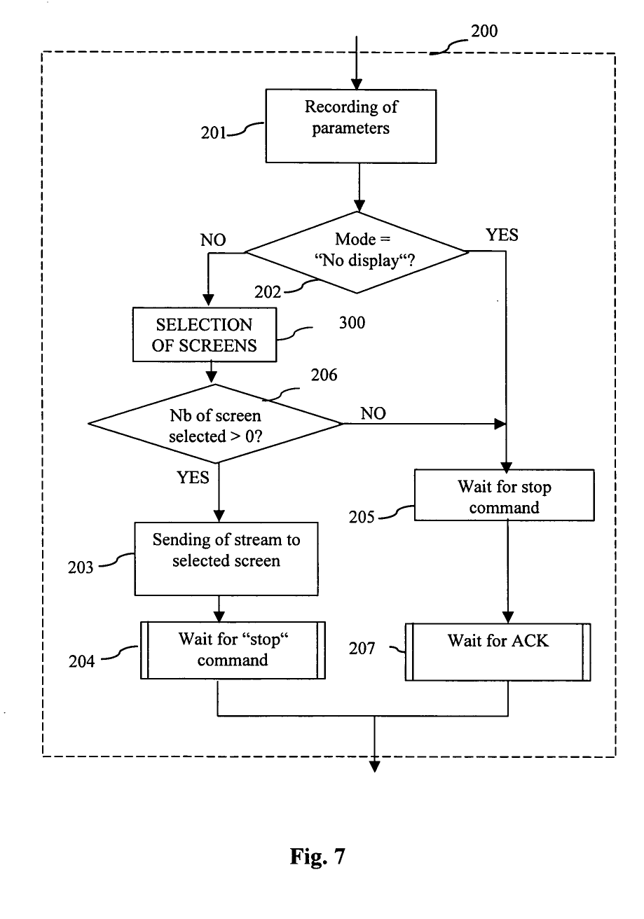

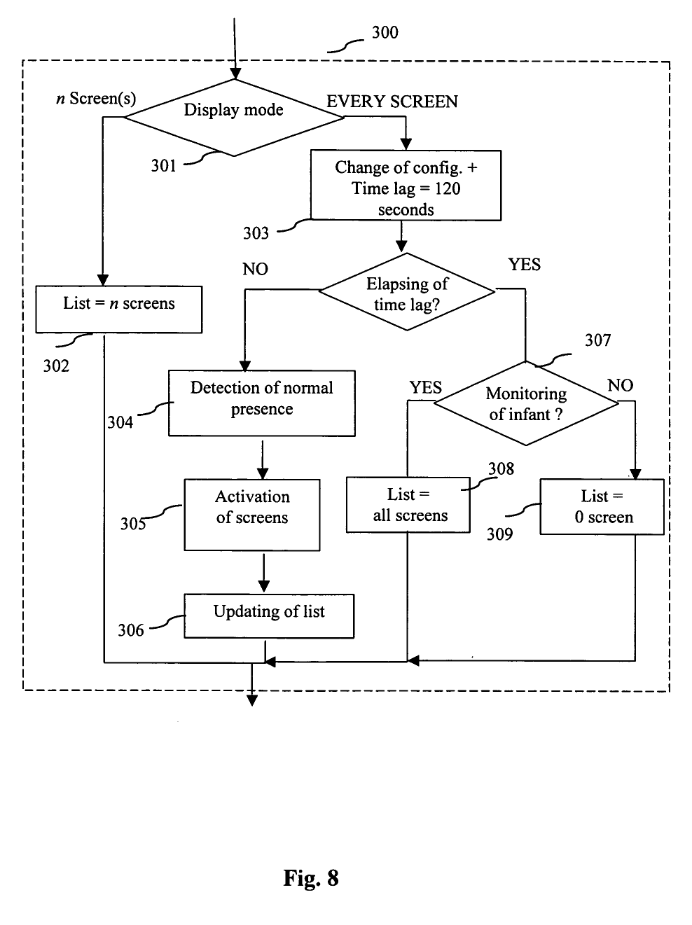

When the desired monitoring service has been selected by the menu 30, the user can choose a mode of display of his monitoring in the menu 31: the menu 31 will propose the following, for example, to the user:
permanent display (which could take the form of an overlay of a video window on a television or computer screen) permanently retransmitting views of the room being filmed;
a “no display” mode which could be chosen, for example, if the monitoring service is activated when all the dwellers of the house are out; and
a mode of display “upon detection of alarm” which will certainly be the most commonly chosen mode and will correspond to the implementation of the detection algorithm illustrated with reference to the total monitoring algorithms illustrated with reference to FIGS. 6a, 6b and 8 and to the activation of the alarm procedure described with reference to FIG. 7.

The menu 32 corresponds to the third step of the configuring of the system. Here, the user defines the room of the house in which the service chosen during the second step is to be provided. The system proposes video monitoring services only in rooms where a camera has been listed beforehand in the network terminal of this room. It is assumed that the names of the rooms of the house (“Thomas's room” etc.) have been defined during the installation of the network or during an updating operation and are therefore accessible through the network terminals.

The menu 33 illustrates the fourth step of the configuring of the system implementing the invention. During this step, the user defines the peripherals of the house assigned to the display of the alarms (or permanent video if this mode has been chosen in the menu 31). In this menu, only display peripherals are proposed by the menu 33, their list being known from information in the possession of the network terminal. Preferably, the user may request the display of the video stream on a part or all the display screens in selecting the corresponding peripheral or peripherals.

Furthermore, the menu 33 proposes the “every screen” option to the user, in order to authorize the sending of an alarm signal, if necessary, to every screen located in a room where a “normal” presence of a dweller of the house is detected without a priori knowledge of this room according to the algorithm illustrated with reference to FIG. 8. Preferably, this possibility is reserved for the mode of display upon “detection of alarm” proposed in the menu 21 since, with such an option, the “permanent display” mode would generate substantial data traffic.

The menu 34 enables a management of the thresholds and more specifically proposes two sub-menus:
a sub-menu for defining the duration of the monitoring window, in terms of 1-second steps (a 30-second default duration, for example, for the monitoring of an infant and a 5-second duration for intruder detection); and
a sub-menu assigned to the choice of the alarm level (for example low sensitivity, medium sensitivity or high sensitivity).

Preferably, through the menu 34, the user can modify the configuration of the duration of monitoring windows and of the alarm level so as to fit them to his or her own criteria (for example his or her infant's behavior).

FIG. 5 illustrates a table 35 for assigning a camera to a service enabling a single system to manage several video monitoring services. This table 35 has four columns:
a first column identifying the camera or cameras;
a second column indicating the associated application;
a third column specifying the technique of motion detection; and
a last column corresponding to the type of video transmission and to the display screens concerned.

The list of all the cameras of the house can be seen in the first column (for example “child's room” “infant's room”, “mezzanine” and “sitting-room”). For each of the cameras, the service chosen at the first step of configuring, through the menu 30, is recorded in the second “Application” column. Each type of monitoring corresponds to a motion detection technique implemented in the network terminal associated with the room in which the concerned camera is located.

The third column specifies a motion detection technique assigned to the corresponding camera of the first column, for example “fast motion”, appropriate to intruder detection and “slow motion” corresponding rather to the monitoring of infants. In this case, a parameter L is defined (through the menu 34) as being equal for example to 30 seconds: this parameter is important because the detection of slow motion could also be required over much shorter periods in the case of the detection of “normal” presence as specified in the algorithms illustrated here below.

Finally, in its last column “video transmission and display screen”, the table 35 indicates whether the video stream received from the corresponding camera must be transmitted on the network or not when an alarm is detected and, if so, which display screens are concerned.

According to one alternative embodiment, the table 35 is split up into several tables. Thus, the table 35 is split up, for example, into two tables:
one table associating each camera with an application; and
one table defining the configuration parameters proper to each application (especially the detection mode).

After the configuring or updating of this table during a reset step 100, the system and more specifically one or more network terminals implement a procedure of video monitoring as illustrated with reference to FIGS. 6a and 6b.

The table 35 presented with reference to FIG. 5 is shared among (or accessible to) all the nodes 20 to 24. Each node 20 to 24 is then in charge of executing the video monitoring procedure now described to analyze all the video streams that are transmitted to it by cameras which are not on “standby” according to the table 35.

The video monitoring procedure starts with a test 101, during which the nodes 20 to 24 determine whether the format of the video to be processed is of the mini-DV or MPEG-2/MPEG4 type.

In order to properly understand the scope of the invention, we shall now briefly recall the basic features of the video encoding that are found today in commercially distributed camescopes or video cameras.

There are two main techniques of video encoding:
motion-based encoding (for example of the MPEG type);
and frame-based encoding (for example of the mini-DV, Motion-JPEG type).

Motion-based encoding distinguishes between inter images and intra images in a video sequence:
intra images are encoded in isolation, without reference to other images, preferably according to a JPEG type technique (essentially comprising three steps: DCT transform to pass into the frequency domain, quantification of the coefficients to eliminate a maximum of high-frequency information to which the human eye has low sensitivity, and entropy encoding to achieve lossless compression of the information obtained up to that point). They are designed to obtain the even distribution of information and prevent the excessive propagation, in a sequence, of any errors that may have been retrieved during this sequence; and
inter images may be encoded from either intra images or other inter images; in both cases, it is sought to define an image i from a reference image r in estimating and encoding the motion between these two frames (in the rest of this document, the terms “frame” and “image” will be used interchangeably). The purpose of this motion estimation is to reduce the amount of information necessary for the encoding of the image through the use of the very great temporal redundancy in a video sequence, where the 25 or 30 images acquired per second necessarily show many similarities.

The image r is generally situated before the image i, but MPEG provides for modes in which the image r is situated after the image i (this will imply a specific ordering of the data during transmission). According to the MPEG standards, the intra images are called I images, and the inter images are called P (predictive-encoded) images and B (bi-directional encoded) images; i.e. images capable of referring to a future image and a past image.

The encoding of an image r from an image i consists in searching for motion, defined on the basis of motion vectors estimated between blocks (of 8×8 pixels for example) or more frequently macro blocks (16×16 pixels). Each (macro) block of the image i is analyzed and a search is made in all the image blocks (or a part of the image blocks) r in order to find those blocks that can be most easily put into a state of correspondence. Classically, the technique of placing blocks in correspondence can be used to find the two-dimensional (horizontal and vertical) translation vectors which minimize the difference between the current (macro) block of the image i and the application of the motion vector found on the (macro) block of the image r. The application of this motion vector is called motion compensation, and the block obtained after this compensation is a prediction of the current block of the image i.

The motion encoding will therefore consist in the encoding of:
the vector found;
the error corresponding to the difference between the current block of the image i and its prediction. This error will then be transformed by a DCT, then quantified and finally encoded entropically.

Frame-based encoding distinguishes only intra images, and therefore does not include motion as such. The compression rate of such an encoding is lower than that of an MPEG type encoding, because it does not exploit temporal redundancy. However, it has the advantage of limited encoding time, the search for the motion vectors being a very costly process.

If, during the test 101, the node detects that the images are mini-DV type images, then the encoding is frame-based and each image is therefore encoded in JPEG, independently of the other images of the sequence.

The images are either digital or analog images; the node receiving the images determine their digital or analog nature, contained in a transportation packet, by reading the header of this packet.

According to the embodiment described, which is both simple and low-cost, if the images come from a digital camera (for example the cameras 11 to 14) connected to an IEEE 1394 port, the detection of the type of video stream will be done by the reading (according to the IEEE 1394.1 standard) of the field known as the “stream type” field in the configuration table known as the “config rom” of the camera. According to one alternative embodiment, the node analyses the headers in the streams received to determine their nature.

If the images come from an analog camera, by default, it is assumed that only MPEG streams are available.

Then, during a test 102, the node checks whether the monitoring service desired corresponds to a detection of fast motion or of slow motion by consulting the parameters of the corresponding camera as shown in table 35.

If a detection of fast motion is sought, all the images corresponding to the last five seconds of the video are analyzed, in a step 103, to estimate their motion activity (the number 5 being a modifiable parameter of the system).

For this purpose, any motion estimation technique known to those skilled in the art is applied. Preferably, since what is sought essentially is a sudden change in a stream of images such as the appearance of an individual in a room representing a static scene, the operation can be limited to obtaining the difference between all the consecutive images during the step 103 and ascertaining that the totalized difference is below a certain threshold during a test 104.

This threshold “of normality” is an internal piece of data of the system, preferably modifiable by the menu 34. It is high enough to take account of small “normal” motions, if any, in a scene such as the rustling of a curtain or a change in illumination without any crossing of the threshold. At the same time, it is low enough to detect any abnormal motion.

If the difference is above a threshold of normality S1, then an alarm procedure 200 illustrated with reference to FIG. 7 is activated and then the step 101 is repeated.

If not, a step 107 determines whether the chosen display mode corresponds to a permanent display of the monitoring video streams.

If the answer is affirmative, then during a step 108, the video stream is transmitted to the peripherals predefined during the configuring phase in the menu 33.

If the answer is negative, or after the step 108, the step 101 is reiterated.

As a variant, instead of repeating the step 101, the method returns directly to the step 103 or 105 corresponding to the application in progress in order to prevent the repeating of the steps 101, 102 and 109 at each new image to be analyzed.

If, during the test 102, the system identifies the fact that a detection of slow motion is desired, all the images corresponding to the last L seconds of the video image are analyzed during a step 105 to estimate their motion activity. In the case of infant monitoring especially, L corresponds to a period equal, for example, to 30 seconds. This value present in the table 35 can be modified at any time by the user. The motion activity will be estimated here by adding up all the differences from one image to another.

Then, during a test 106, the system determines whether this activity is normal or not by checking to see whether the sum of the differences is higher than a threshold S2. S2 is preferably different from the threshold S1 used during the test 104 because the search here is being made not necessarily for a “sudden” “motion” but for any motion that might last for an (excessively) lengthy period.

If the test 106 indicates that the difference is above the permitted threshold S2, then we are in the presence of an excessively lengthy and therefore suspicious motion, and the alarm procedure 200 is activated and then the step 101 is repeated.

If not, the test 107 described here above is implemented.

According to one alternative embodiment of the invention, the algorithm of FIG. 6a is modified as follows:
the test 102 is eliminated;
the step 103 is replaced by the step 105, the parameter L being initialized at 5 seconds by default for a fast motion detection; and
the tests 104 and 106 merge into a single test, the thresholds S1 and S2 being replaced by a threshold S, the applicable values of S being equal to S1 or S2 depending on the type of detection and being memorized in the table 35.

If, during the test 101, the node detects the fact that the video format is of the MPEG-2 or MPEG-4 type, then the system is in the presence of a motion-based video encoding.

In this case a test 109 is then performed. This test 109 determines whether the desired monitoring service corresponds to a detection of fast motion or a detection of slow motion.

In the case of a search for fast motion, during a step 110, the system estimates the activity corresponding to motions by totalizing all the motion vectors of the images acquired during the last five seconds (this parameter of duration being modifiable by the user).

The step 110 is close to the step 103, one difference being that the estimation of the motion activity is done on the basis of the vectors generated by the camera for the encoding of the inter images. After the step 110, the motion activity having been estimated, the system executes a test 111 comparable to the above-described tests 104 and 106, the only difference being the value of the threshold of normality S3, which is adapted to the specific values of the motion vectors (these are spatial translation coordinates).

If the result of the test 111 is positive, the alarm procedure 200 is activated, and then the step 101 is reiterated.

If not, the step 107, as described here above is executed.

When the result of the test 109 is negative, the system detects a slow motion on a duration L.

The step 112 is therefore aimed at estimating this motion as described in the step 110, but this time on all the images of the duration L.

Then, during a test 113, the system determines whether this activity goes beyond a threshold of normality S3 (which can be parametrized by the user).

If the answer is affirmative, the alarm procedure 200 is activated and then the step 101 is reiterated.

If the answer is negative, the step 107 is executed.

According to an alternative embodiment of the invention, the algorithm of FIG. 6a is modified as follows:
the test 109 is eliminated;
the step 110 is replaced by the step 112, the parameter L being initialized at 5 seconds by default for a fast motion detection; and
the tests 111 and 113 merge into a single test, the thresholds S3 and S4 being replaced by a threshold S′, the applicable values of S′ being equal to S3 or S4 depending on the type of detection and being stored in the table 35.

According to one alternative embodiment of the invention illustrated with reference to FIG. 6b and in order to increase the reliability of the video monitoring, one or more terminal-networks of the video monitoring system also use a piece of sound information given by the video monitoring camera or cameras. According to this embodiment of the invention, a sound alarm threshold is defined, this sound alarm threshold representing a sound level beyond which a noise becomes abnormal. A threshold (called a sound threshold_i) is preferably defined for each type of service.

The video monitoring procedure is synchronized with audio monitoring. This procedure does not depend on the type of video used and is very similar in cases of fast or slow detection. Hence, a description is given, with reference to FIG. 6b, of a particular case situated at the exit from the test 102 (as illustrated with reference to FIG. 6a) when a fast motion has to be detected with a Mini-DV type of video format.

The procedure of video monitoring synchronized with audio detection comprises a first step for the resetting or updating of the configuration (not shown) very similar to the step 100 illustrated here above, the table 35 furthermore comprising parameters proper to audio monitoring such as the sound detection thresholds and parameters indicating or not indicating the implementation of the audio detection in addition to video monitoring for each camera. According to different variants, the configuration of the audio monitoring is associated with the camera or service (or application) and is reset either according to a default configuration or by use.

Following the tests 101 and 102 (according to the example shown), a network terminal implements a noise sound detection and a motion video detection in parallel.

The video detection starts with the step 103 for the comparison of video images transmitted by one or more cameras and the test 104 for the analysis of the video threshold, already illustrated with reference to FIG. 6a.

If the result of the test 104 is negative then, in a step 213, the network terminal resets a Boolean value corresponding to the result of video analysis, in the “false” state.

If not, in a step 214, the Boolean value corresponding to the result of video analysis is set in the “true” state.

The audio detection starts with a step 210 for the reception of sound streams coming from one or more cameras.

Then, during the test 211, the network terminal checks to see whether the maximum level recorded during the step 210 is over the threshold associated with the configuration of the camera emitting the corresponding sound stream and/or the type of motion to be detected.

If the result of the test 211 is positive, during the step 212 the network terminal records the current timedate (in erasing the timedate of a previous crossing of the sound level if any).

Following the step 212 or if the result of the test 211 is negative, a test 215 is performed every L seconds (to be synchronized with the verification procedures associated with the video stream). During the test 215, the network terminal checks to see if a crossing of the sound level has occurred during the L last seconds. The value of L corresponds to the duration of analysis of the video images, carried out in parallel (here, for example, five seconds for a fast motion detection). This value depends on the branch of the algorithm taken depending on the type of video or motion to be detected.

When there is no validity test at the current instant (the test having been performed earlier in the L-second period) or if the result of the test 215 is negative, the network terminal executes the step 216 during which it sets a Boolean value corresponding to the result of audio analysis in the “false” state.

If not, a crossing of the sound threshold has been detected during the L last seconds and, during a step 217, the Boolean value corresponding to the result of audio analysis is set in the “true” state.

Following one of the steps 216 of 217 and one of the steps 213 or 214, during the test 218, the network terminal checks to see if at least one of the Boolean values corresponding to audio or video detection is in the “true” state, signifying that at least one motion or one sound has been detected crossing a corresponding threshold for a duration greater than or equal to the L seconds.

If the answer is affirmative, the alarm procedure 200 is activated and then the step 101 is reiterated. If not, the network terminal performs the test 107.

FIG. 6b illustrates the particular case of the processing operation corresponding to the exit from the test 102 when a fast motion has to be detected with a Mini-DV type of video format. The processing with detection of a slow motion with a Mini-DV type video format is similar, the steps 103 and 104 being respectively replaced by the steps 105 and 106. Similarly, the processing of a video stream in an MPEG-2 or MPEG-4 type format or an associated sound stream is also similar to the processing carried out with a stream in the Mini-DV format: the steps 103 to 106 are then respectively replaced by the steps 110 to 113 illustrated with reference to FIG. 6a.

According to one alternative embodiment of the invention implementing a video monitoring operation associated with an audio detection, an alarm procedure 200 is implemented only if both the audio and the video thresholds are reached.

According to another variant, an alarm level is assigned to each type of detection and it is the weighted sum of these levels that activates an alarm if the level crosses a predetermined threshold (thus, if a motion is detected clearly, an alarm procedure will be activated; by contrast, the detection of an uncertain motion could be confirmed or not confirmed as a function of the measurement of a sound level).

According to another alternative embodiment of the invention illustrated with reference to FIG. 6c, only a sample of images of a video sequence are analyzed to estimate the motion activity of that sequence. Such a sub-sampling procedure provides the advantage of decoding and analyzing only a limited number of images and thus the advantage of fast and efficient motion detection.

The procedure of sub-sampling video sequences is very similar in the case of a video stream in Mini-DV type format or in the case of a video stream in an MEPG-2 or MPEG-4 type format. Hence, a description is given, with reference to FIG. 6c, of a particular case situated at the exit from the test 101 (as illustrated with reference to FIG. 6a) when the node has detected that the images are mini-DV type images.

Following the test 102, the procedure of sub-sampling video sequences comprises a test 302 for determining whether the desired monitoring service corresponds to a detection of fast motion or a detection of slow motion. In a case of a search for fast motion, during a step 303, a variable T representing a sampling rate is initialized. T influences the number of images analyzed during a given period of time L. For example, T takes here the value 1/1 meaning that all images will be analyzed (this sampling value being modifiable by the user). If, during the test 302, the system identifies the fact that a detection of slow motion is desired, the sampling rate T is, during the step 304, initialized to another value, which is lower than the value attributed for fast motion (and which can be parameterized by the user). For example, T takes the value 1/3, meaning that 1 out of 3 images of a video sequence will be analyzed. Steps 303 and 304 are followed by step 305, during which, a video sequence is decoded and sub-sampled with the sampling rate T. Then, during a step 306, all decoded images corresponding to the last L seconds of the video images are analyzed. L corresponds to a period equal, for example, to 30 seconds. This value can be modified at anytime by the user. The motion activity will be estimated here by adding up all the differences from one image decoded to another. Then, during a test 307, the system determines whether this activity is normal or not by checking to see whether the sum of differences is higher than a threshold S. If the test 307 indicates that the sum of difference is above the permitted threshold, an alarm procedure is activated, during step 308 and then the step 101 is repeated. If not, a test 309 determines whether the chosen display mode corresponds to a permanent display of the monitoring video streams. If the answer is affirmative, then during a step 310, the video stream is transmitted to the peripherals predefined during the configuration phase in the menu. If the answer is negative, or after the step 309, the step 101 is reiterated.

FIG. 6c illustrates the particular case of the processing operation corresponding to the exit from the test 101 detecting that the images are mini-DV type images. The processing of a video stream in a MPEG-2 or MPEG-4 type format is similar: an intermediary decoding step is simply required between step 101 and 302.

FIG. 7 illustrates the alarm procedure 200 implemented in the monitoring algorithm presented with reference to FIG. 6, when the monitoring application of one of the network terminals requests the generation of an alarm signal or an alarm.

The alarm procedure 200 starts with a step 201, during which the important parameters of this alarm, especially and at least the date, the time and an identifier of the camera that has detected the problem, are recorded in a “report” file. Similarly, the analyzed video stream is preferably kept. According to one variant, the stream being acquired by the camera that has activated the alarm is also recorded until the maximum storage capacities of the network terminal or of the network itself have been reached or until the user requests a halt to the recording (for example by validating the alarm).

Then, during a test 202, the node determines whether a “no display” mode has been chosen during the preliminary configuring step.

If the answer is negative, a procedure 300 is performed, aimed at generating the list of screens selected to receive the alarm signals and warn the dwellers of the house. During the configuring phase, the user selects a “no display” type of configuration or a display with at least one screen. During the procedure 300, if the application requires a display on every possible screen, the system detects a presence, if any, of a dweller in the vicinity of the screen and reroutes the alarm information to the corresponding screen. This information may lead to a change in configuration, the original configuration being stored (step 303 illustrated here below with reference to FIG. 8).

The step 300 is followed by a test 206 which checks to see whether at least one screen has been selected.

If at least one screen has been selected, during a step 203, the analyzed video stream and, as the case may be, the stream that continues to be acquired, are transmitted to the screens corresponding to the list of selected screens. This step assumed an updating of the table 35 illustrated in FIG. 5, and especially of the “video transmission” column in order to pass this value to “permanent display” for the camera concerned (if this value is different before the step 203).

According to one variant of the invention, this step comprises the activation of a sound alarm in imposing an audio signal on the sound systems associated with the selected screens.

The alarm procedure then terminates with a step 204 which awaits validation by the user, thus certifying that he has obtained knowledge of the alarm and that it can therefore be stopped. This validation can take place, for example, by action on the remote control of the system. If, during the step 300, the configuration has been modified to detect presence then, during the step 204, the system switches to the original configuration memorized.

If the test 202 shows that no display was requested, the dwellers of the house are assumed to be absent and the alarm therefore relates to an intrusion.

Following a positive result of the test 202 or a negative result of the test 206, during a step 205, an external alarm is activated. This is an alarm such as the sending of a message to the police (for example through an automatic dialing of the police number and a connection to a pre-recorded message). According to one variant of the invention, this external alarm includes an automatic sending of an SIMS (“Short Message Service”) type message on a predetermined mobile telephone chosen by the dwellers of the houses being monitored, for example through an automatic activation of the services proposed by the mobile telephony operators on the Internet.

After the step 205, the alarm procedure ends with a step 207 in which there is a wait for an acknowledgement of reception indicating that the alarm has been taken into account through a specific return signal. If, during the step 300, the configuration has been modified to detect the presence, then during the step 207, the system switches to the original configuration memorized.

FIG. 8 illustrates the procedure 300 for the selection of screens to which an alarm (or an alarm signal) is rerouted during the corresponding procedure 200.

The procedure 300 starts with the test 301 which enables the selection of the display screens. During the test 301, the system verifies whether, in the table 35, the video monitoring service that has activated the alarm had been predefined according to the menu 33 with certain display screens or whether all the recorded screens of the house are potential screens for the reception of alarms.

Should one or more screens have been selected, then during a step 302, the procedure 300 returns a list of screens that have to display the alarm, containing all these screens.

If not, what has to be done now is to find the screens of the houses best suited to receiving this alarm (or an alarm signal). In particular, the invention will try to detect those rooms in which the dwellers of the house are located in order to warn them on the corresponding screens. For this purpose, in a step 303, the system memorizes the current table 35 and updates it so that all the cameras of the house which were not being used for video monitoring go into the technique of “slow motion” detection with the parameter L equal to 30 seconds. Indeed, the cameras installed in the house must now swiftly detect a normal presence which will necessarily correspond to a small motion since a person can practically never remain perfectly still.

Then, during a step 304, the system launches a time lag (that can be parametrized in the system and is equal, for example, to two minutes by default) and places itself in the state of waiting for the detection of a presence.

If the time lag elapses without the detection of a presence, the procedure 300 continues with a test 307 to determine whether the service corresponding to the initial stream that has generated an alarm is of the infant monitoring type.

If the answer is affirmative then, during a step 308, the procedure 300 sends back a list of screens that have to display the alarm. This list contains all the available screens.

If the answer is negative, the procedure 300 sends back a blank list of screens that have to display the alarm since no screen is selected.

If the system detects the presence before the end of the time interval, naturally a corresponding alarm procedure is not activated since the presence detected is considered to be normal. During a step 305, the system activates the display peripherals of these rooms if they are listed as being “inactive” in the system of the network. This activation is made possible through commands known as “AV/C”, commands which may also be used to activate the cameras identified in the step 303. These commands enabling the activation of the inactive peripherals are described especially in the document “AV/C Digital Interface Command Set” published by the audio/video working group of the 1394 Trade Association. The link with the cameras is preferably of the IEEE 1394 type (for example defined by the IEEE 1394-1995 and/or IEEE 1394a-2000 standards) whose functions enable the implementation of the AV/C commands. Thus, when a camera is connected to an IEEE1394 serial bus without being powered beforehand, its IEEE 1394 physical layer is powered by the other devices connected to the same serial bus. A node of this serial bus may request the activation of the IEEE 1394 link (LINK) by means of particular packet called LINK-ON. The AV/C specifications then enable the activation of the AV/C units of the camera by means of a POWER type AV/C command. It is then possible to make the camera come into operation in the setting up of the communication (also called a connection), which for example is of the isochronous type as is the case for the transfer of video streams. The setting up of an isochronous type communication on an IEEE1394 serial bus is described in the IEC61883-1 standard, supplemented by the IEEEP1394.1 standard when this connection uses a bridge between the source device and the destination device.

The AV/C commands may also be used to place a television set in a mode enabling the display of a video stream. More specifically, if the television set is connected to a terminal of the network by its analog interface, the AV/C commands cannot be used directly. Should the device (the terminal detecting the alarm) wishing to set up a connection with this television set generate an AV/C type command or more generally an IEEE1394 type command, the terminal to which the television set is connected will have to convert the AV/C command into an appropriate infrared code that can be interpreted by the television set. This necessitates a phase for the configuring of the terminal or a phase for the learning of the infrared codes that can be interpreted by the television set. Such a method is described especially in the patent application FR 0110355.

Then, during a step 306, the procedure 300 builds a final list of screens that it returns. This list includes the peripherals screens thus identified during the step 304 and the peripherals activated and listed as being “active” in the system.

Naturally, the invention is not limited to the exemplary embodiments mentioned here above.

In particular, those skilled in the art will be able to provide any variant in the type of home network implementing the invention, in its structure (linear, star or meshed layouts, etc.) as well as in the communications protocols implemented or in the devices connected to this network (television sets, computers, terminals of any kind, camescopes, video recording tools, etc).

It can be noted that the invention is not limited to the monitoring of children or to intruder detection but can be extended to any type of monitoring of an entity whose motion can be picked up by a camera (for example an apparatus being monitored, an animal etc).

It can be noted that the invention is not limited to a purely hardware layout by can also be implemented in the form of a sequence of instructions of a computer program or at any form combining a hardware part and a software part. Should the invention be implanted partially or totally in software form, the corresponding sequence of instructions could be stored in a storage means that is detachable (such as for example a floppy, a CD-ROM or a DVD-ROM) or not detachable, this storage means being partially or totally readable by a computer or microprocessor.

1. A video monitoring device, comprising
receiving means for receiving a video stream from a video source,
manually operable means for setting a detection mode among at least two modes, the detection mode being solely set for the video source;
motion detection means for detecting motion in the video stream in accordance with the detection mode set by said manually operable means, said motion detection means obtaining and computing a set of images from the video stream according to the detection mode; and
output means for outputting the result regarding to the motion detected by said detection means.

2. A device according to claim 1, wherein at least a number of images within the set of images obtained by said motion detection means and duration of the video stream during which the set of images are obtained by said motion detection means are determined according to the detection mode.

3. A device according to claim 1, wherein said output means includes alarm means for generating an alarm signal based on the motion detected by said motion detection means.

4. A device according to claim 3, further comprising means for detecting sound level in an audio stream associated with the video stream, and wherein said alarm means generates the alarm signal if the weighted sum of the detected sound level and level of the motion detected by said motion detection means is above a threshold that is dependent on the detection mode set for the video source.

5. A device according to claim 3, wherein said alarm means includes selecting means for selecting a video display among a plurality of displays and supply means for supplying the video stream to the selected video display.

6. A device according to claim 5, wherein said receiving means is capable of receiving a plurality of video streams from a plurality of video sources, said selecting means selects the display closer to a video source belonging to a predetermined set of video sources.

7. A device according to claim 6, wherein said predetermined set of video sources includes all the video sources among the plurality of video sources but the one from which the video stream causing the alarm signal is received.

8. A device according to claim 1, wherein the video stream is intra-frame encoded and said motion detection means includes means of computing difference between images within the obtained set of images.

9. A device according to claim 1, wherein the video stream is inter-frame encoded and said motion detection means uses motion vectors associated with an image within the obtained set of images.

10. A video monitoring device, comprising
an input receiving a video stream from a video source,
a manual operable member setting a detection mode among at least two modes, the detection mode being solely set for the video source;
a motion detector detecting motion in the video stream in accordance with the detection mode set by the manual operable member, the motion detector obtaining and computing a set of images from the video stream according to the detection mode; and
an output outputting the result regarding to the motion detected by the motion detector.

11. A device according to claim 10, wherein at least a number of images within the set of images obtained by the motion detector and duration of the video stream during which the set of images are obtained by the motion detector are determined according to the detection mode.

12. A method of video monitoring, comprising
a step for receiving a video stream from a video source,
a step for manually setting a detection mode among at least two modes, the detection mode being solely set for the video source;
a step for detecting motion in the video stream in accordance with the detection mode set, in order to obtain and compute a set of images from the video stream according to the detection mode; and
a step for outputting the result regarding to the motion detected.

13. A method according to claim 12, wherein at least a number of images within the set of images obtained by said step for detecting motion and duration of the video stream during which the set of images are obtained by said step for detecting motion are determined according to the detection mode.

14. A method according to claim 12, wherein said step for outputting includes a step for generating an alarm signal based on the motion detected by said step for detecting motion.

15. A method according to claim 14, further comprising a step for detecting sound level in an audio stream associated with the video stream, and wherein said step for generating an alarm signal allows to generate the alarm signal if the weighted sum of the detected sound level and level of the motion detected by said motion detection means is above a threshold that is dependent on the detection mode set for the video source.

16. A method according to claim 14, wherein said step for generating an alarm signal includes a step for selecting a video display among a plurality of displays and a step for supplying the video stream to the selected video display.

17. A method according to claim 16, wherein said step for receiving allows to receive a plurality of video streams from a plurality of video sources, said step for selecting allowing to select the display closer to a video source belonging to a predetermined set of video sources.

18. A method according to claim 17, wherein said predetermined set of video sources includes all the video sources among the plurality of video sources but the one from which the video stream causing the alarm signal is received.

19. A method according to claim 12, wherein the video stream is intra-frame encoded and said step for detecting motion includes a step for computing difference between images within the obtained set of images.

20. A method according to claim 12, wherein the video stream is inter-frame encoded and said step for detecting motion uses motion vectors associated with an image within the obtained set of images.

21. A computer program product comprising computer program code means for performing the steps of any one of method claims 12 to 20 when said computer product is run on a computer.

22. A computer readable storage medium, possibly partially or totally removable, storing a set of machine executable instructions, said set of machine executable instructions being executable by a computer to perform the steps of method claims 12 to 20.
